(19) United States
(12) Patent Application Publication
(10) Pub. No.: US 2025/0148455 A1
(43) Pub. Date: May 8, 2025

(54) ACCESS CONTROL TOWER

(71) Applicant: Wells Fargo Bank, N.A., San Francisco, CA (US)

(72) Inventors: Brian M. Pearce, Pleasanton, CA (US); Benjamin Soccorsy, Larkspur, CA (US)

(73) Assignee: Wells Fargo Bank, N.A., San Francisco, CA (US)

(21) Appl. No.: 19/018,797

(22) Filed: Jan. 13, 2025

Related U.S. Application Data
(63) Continuation of application No. 18/126,773, filed on Mar. 27, 2023, now Pat. No. 12,198,130.
Application No. 18/126,773 is a continuation of application No. 15/629,423, filed on Jun. 21, 2017, now Pat. No. 11,615,402.
(60) Provisional application No. 62/357,737, filed on Jul. 1, 2016.

(51) Int. Cl. G06Q 20/36; H04L 9/40

(52) U.S. Cl. CPC G06Q 20/3674; H04L 63/083

(57) ABSTRACT

Systems, methods, and apparatuses for providing a customer a central location to manage permissions provided to third-parties and devices to access and use customer information maintained by a financial institution are described. The central location serves as a central portal where a customer of the financial institution can manage all access to account information and personal information stored at the financial institution. Accordingly, the customer does not need to log into each individual third-party system or customer device to manage previously provided access to the customer information or to provision new access to the customer information.

### CROSS-REFERENCE TO RELATED APPLICATIONS

This application is a continuation of U.S. patent application Ser. No. 18/126,773 filed Mar. 27, 2023 (now U.S. Pat. No. 12,198,130), which is a continuation of U.S. patent application Ser. No. 15/629,423 filed Jun. 21, 2017 (now U.S. Pat. No. 11,615,402), which claims priority to U.S. Provisional Patent Application No. 62/357,737 filed Jul. 1, 2016, each of which is incorporated herein by reference in its entirety.

### TECHNICAL FIELD

Embodiments of the present disclosure relate to systems and methods for managing user data and user preferences across a plurality of platforms.

### BACKGROUND

Many customers link information (e.g., account types, account balances, payment account information, etc.) maintained by a financial institution to devices (e.g., in a mobile wallet on a smartphone, wearable devices, Internet of Things devices, etc.) and to third-party systems (e.g., financial health monitoring services, merchant e-commerce systems, social media platforms, mobile wallet systems, etc.). Often, to enable access to the information maintained by the financial institution, the customer provides the third-party login credentials or authorizes the third-party to access the information maintained by the financial institution via an application program interface (“API”) offered by the financial institution. The customer may share the information with a plurality of different services. For example, the customer may authorize the financial institution to provide account information to a financial health monitoring service, payment card information to a plurality of different mobile wallet services, payment card information to their favorite retailers, and the like. Once the access is provided, the customer can manage preferences relating to the access at each of the third-party systems (e.g., via a third-party website or smartphone application). However, this process can be cumbersome when the customer has authorized a plurality of third-parties to have access to the information maintained by the financial institution.

### SUMMARY

Various example embodiments relate to systems and methods for providing a centralized system for providing, modifying, and revoking third-party access to information maintained by a financial institution. One such example embodiment relates to a method of managing access to customer information associated with a customer of a financial institution. The method includes providing, by a financial institution computing system associated with the financial institution, access to a data control portal to a computing device associated with the customer. The method further includes receiving, by the financial institution computing system and from the computing device, access permissions associated with the customer information that change. The access permissions define how an external device or system can access or utilize the customer information. The method includes implementing, by the financial institution computing system, the access permissions. The method further includes updating, by the financial institution computing system, a user interface of the data control portal displayed at the computing device to reflect the access permissions.

Another example embodiment relates to a financial institution computing system associated with a financial institution. The system includes a network interface structured to facilitate data communication via a network. The system further includes an accounts database structured to customer information associated with customers of the financial institution. The system includes a processing circuit comprising a processor and memory. The processing circuit is structured to provide access to a data control portal to a computing device associated with a customer of the financial institution. The processing circuit is further structured to receive, from the computing device, access permissions associated with the customer information that change. The access permissions define how an external device or system can access customer information associated with the customer. The processing circuit is structured to implement the access permissions, and to update a user interface of the data control portal displayed at the computing device to reflect the access permissions.

These and other features, together with the organization and manner of operation thereof, will become apparent from the following detailed description when taken in conjunction with the accompanying drawings.

### BRIEF DESCRIPTION OF THE FIGURES

FIG. 1 is a view of a system that facilitates the sharing of customer information from a financial institution to customer devices and to third-parties according to an example embodiment.

FIG. 2 is a view of a flow diagram of a method of managing access to customer information maintained by a financial institution according to an example embodiment.

FIGS. 3 through 5 each show example data control tower user interfaces according to example embodiments.

### DETAILED DESCRIPTION

Referring to the figures generally, systems, methods, and apparatuses for providing a customer a central location to manage permissions provided to third-parties and devices to access and use customer information maintained by a financial institution are described. The central location serves as a central portal where a customer of the financial institution can manage all access to account information and personal information stored at the financial institution. Accordingly, the customer does not need to log into each individual third-party system or customer device to manage previously provided access to the customer information or to provision new access to the customer information.

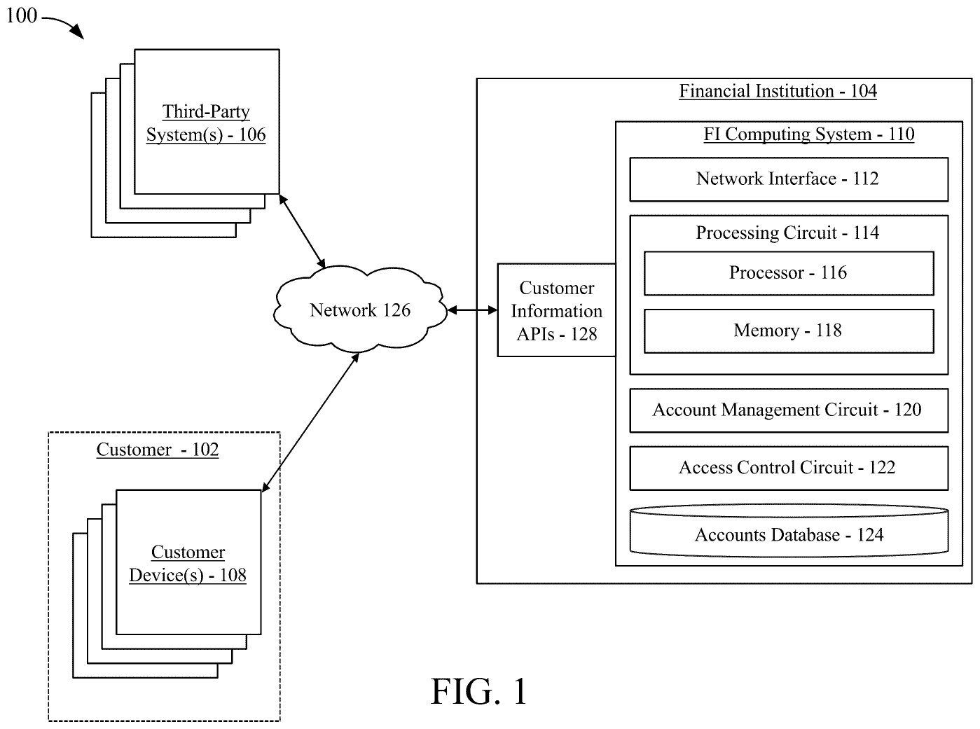

Referring to FIG. 1, a view of a system 100 is shown according to an example embodiment. As described below in further detail, the system 100 facilitates the sharing of customer information associated with a customer 102 and maintained by a financial institution 104 to third-parties systems 106 and customer devices 108. The shared customer information can include any combination of account information associated with financial accounts held by the customer 102 with the financial institution 104 (e.g., types of accounts owned, account numbers, account balances, transaction information, bill due dates, etc.) and customer personal information stored by the financial institution 104.

The customer 102 is an account holder with the financial institution 104. The financial institution 104 includes a financial institution (FI) computing system 110. The FI computing system 110 maintains information about accounts held with the financial institution 104 and facilitates the movement of funds into and out of the accounts. Additionally, the FI computing system 110 facilitates the sharing of and the provision of access to information associated with customer accounts to the customer 102, to customer devices 108, and to third-party systems 106. The financial institution computing system 110 includes a network interface 112. The network interface 112 is structured to facilitate data communication with other computing systems (e.g., the customer devices 108, the third-party systems 106, etc.) via a network 126. The network interface 112 includes hardware and program logic that facilitates connection of the FI computing system 110 to the network 126. For example, the network interface 112 may include a wireless network transceiver (e.g., a cellular modem, a Bluetooth transceiver, a WiFi transceiver, etc.) and/or a wired network transceiver (e.g., an Ethernet transceiver). In some arrangements, the network interface 112 includes the hardware and programming logic sufficient to support communication over multiple channels of data communication (e.g., the Internet and an internal financial institution network). Further, in some arrangements, the network interface 112 is structured to encrypt data sent over the network 126 and decrypt received encrypted data.

The financial institution computing system 110 includes a processing circuit 114 having a processor 116 and memory 118. The processor 116 may be implemented as a general-purpose processor, an application specific integrated circuit (ASIC), one or more field programmable gate arrays (FPGAs), a digital signal processor (DSP), a group of processing components, or other suitable electronic processing components. The memory 118 includes one or more memory devices (e.g., RAM, NVRAM, ROM, Flash Memory, hard disk storage, etc.) that store data and/or computer code for facilitating the various processes described herein. Moreover, the memory 118 may be or include tangible, non-transient volatile memory or non-volatile memory.

The FI computing system 104 includes an account management circuit 120 and an access control circuit 122. Although shown as separate circuits in FIG. 1, in some arrangements, the account management circuit 120 and/or the access control circuit 122 are part of the processing circuit 116. Other arrangements may include more or less circuits without departing from the spirit and scope of the present disclosure. Further, some arrangements may combine the activities of one circuit with another circuit to form a single circuit. Therefore, those of ordinary skill in the art will appreciate that the present arrangement is not meant to be limiting. The account management circuit 120 is structured to perform various account management functions, including maintaining an accounts database 124, updating account balances, applying interest to accounts, processing payments related to accounts, and the like. The access control circuit 122 is structured to manage the sharing and provision of customer information to third-party systems 106 and to customer devices 108 based on permissions and preferences of the customer 102.

The FI computing system 104 includes the accounts database 124. In some arrangements, the accounts database 124 is part of the memory 118. The accounts database 124 is structured to hold, store, categorize, and otherwise serve as a repository for information associated with accounts (e.g., loan accounts, savings accounts, checking accounts, credit accounts, etc.) held by the financial institution 104. For example, the accounts database 124 may store account numbers, account balances, transaction information, account ownership information, and the like. The accounts database 124 is structured to selectively provide access to information relating to accounts at the financial institution 104 (e.g., to the customer 102 via a customer device 108).

Still referring to FIG. 1, the system 100 includes at least one third-party system 106. Each third-party system 106 is affiliated with a third-party that the customer 102 can authorize to access information associated with the customer 102 that is stored, generated, maintained, and/or controlled in part by the financial institution 104. For example, the third-party systems 106 may be affiliated with any combination of merchants (e.g., brick-and-mortar retailers, e-commerce merchants, etc.), financial health companies (e.g., investment firms, Mint®, etc.), mobile wallet systems (e.g., third-party mobile wallet systems not affiliated with or operated by the financial institution 104, mobile wallet systems affiliated with or operated by the financial institution 104), payment networks (e.g., payment networks affiliated with credit cards offered by the financial institution 104), social media networks, service providers, utility providers (e.g., electric companies, cable companies, cell phone providers, gas companies, etc.), messaging networks, personal organizers (e.g., calendar and scheduling services, bill pay services, e-mail systems, etc.), governments, or the like. Each of the third-parties may be provided access to different portions of the information associated with the customer 102 that is stored, generated, maintained, and/or controlled in part by the financial institution 104. For example, an e-commerce merchant may be provided access to payment account and billing address information, while a financial health company may be provided access to account balance information and transaction information. As described in further detail below, the customer 102 can provide a given third-party access to designated information, limit access to information, and revoke access to information through an access control portal (“access control tower”) provided by the financial institution 104.

The customer 102 is associated with various customer devices 108. The customer devices 108 may include, for example, smartphones, tablet computes, laptop computers, desktop computers, wearables (e.g., smart watches, smart glasses, fitness trackers, etc.), internet of things (“IOT”) devices (e.g., Amazon Echo®, smart appliances, etc.). Each of the customer devices 108 may be provided access to different portions of the information associated with the customer 102 that is stored, generated, maintained, and/or controlled in part by the financial institution 104. For example, a smartphone may be provided access to payment account and billing address information for a mobile wallet running on the smartphone, while an IOT device may be provided access to payment information, account balance information, and transaction information to execute purchases and review transactions. As described in further detail below, the customer 102 can provide a given customer device 102 access to designated information, limit access to information, and revoke access to information through the access control tower provided by the financial institution 104. In some arrangements, the customer devices 108 do not communicate with the FI computing system 110 via the network 126. For example, the customer devices 108 can include payment cards (e.g., credit cards, debit cards, smart cards, etc.) that have account information that can be linked by the FI computing system 110 to account information and customer preferences stored at the FIG. computing system 110.

The devices of the system 100 communicate via the network 126. The network 126 may include any combination of the Internet and an internal private network (e.g., a private network maintained by the financial institution 104). Through data communication over the network 126, the FI computing system 110 can share customer information with the third-party systems 106 and the customer devices 108. The FI computing system 110 includes customer information APIs 128 that define how the FI computing system 110 communicates customer information with the third-party systems 106 and the customer devices 108. The APIs facilitate the sharing of and access to the customer information stored at the FI computing system 110 based on permissions and preferences provided by the customer 102. The access control circuit 122 access to the customer information by the third-party systems 106 and the customer devices 108 via the APIs 128. In some arrangements, the FI computing system 110 provisions requested customer data to a given third-party system 106 or customer device 108 for local storage on the third-party system 106 or the customer device 108. For example, the FI computing system 110 can provision payment information, such as payment tokens associated with payment accounts, to a mobile wallet system for local storage at the mobile wallet system. In other arrangements, the FI computing system 110 provides access to remotely display, present, or analyze customer information stored at the FI computing system while the FI computing system 110 retains control over the customer information. For example, the FI computing system 110 can provide access to a financial health system to present designated customer account information through a financial health website, such as balances, transaction information, and the like, when the financial health system requests the information, without directly transmitting the data to the financial health system.

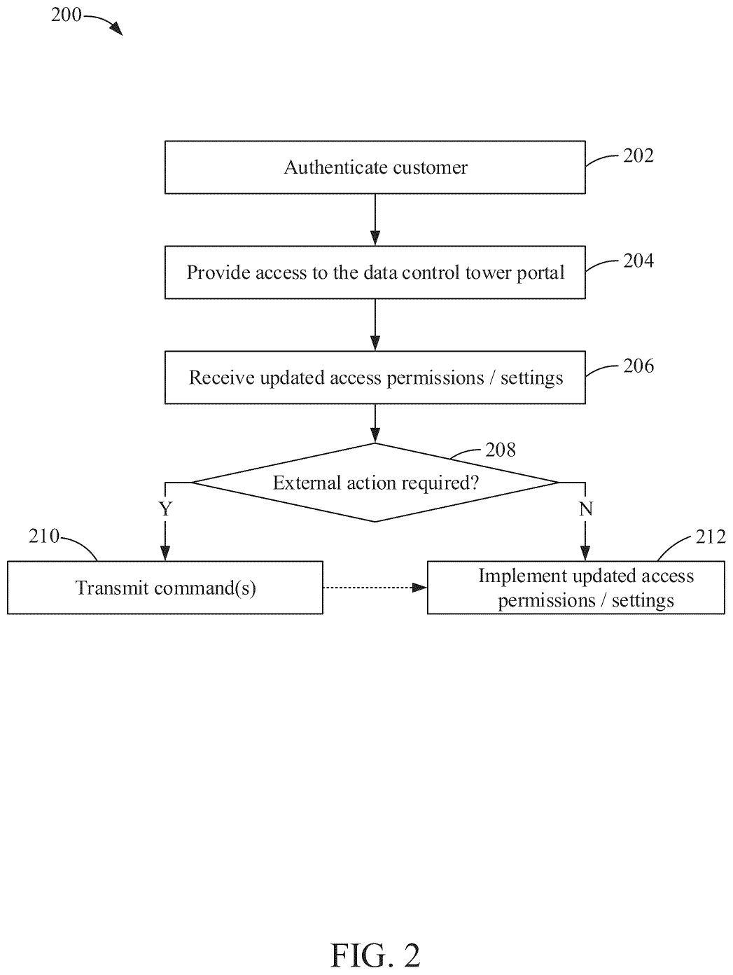

Generally, through the system 100, the customer 102 can provision access to customer information to third-party systems 106 and to customer devices 108 (e.g., by permitting the third-party system 106 or the customer device 108 to communicate with the FI computing system 110 to retrieve the customer information). The customer information is maintained by the financial institution 104 via the FI computing system 110. The customer information can include any information associated with the customer 102 that is generated by or maintained by the financial institution 104, including customer account information (e.g., account numbers, billing address, balance information, transaction information, account type information, etc.) and personal information (e.g., date of birth, social security number, tax identifications, addresses, phone numbers, e-mail addresses, aliases, etc.). The customer 102 can provision access to the customer information through the third-party, the customer device 108, or via the FI computing system data control tower. Additionally, the customer 102 can manage all previously provided access permissions via the data control tower to change an access level, set permissions, revoke access, or the like. The provision of the customer information can be managed on an account level (e.g., managing all third-party and device access to a specific account) or on a channel level (e.g., managing all the information that a given customer device 108 or third-party system 106 can access). The operation of the system 100 is described in further detail below with respect to FIGS. 2 through 5.

Referring to FIG. 2, a flow diagram of a method 200 of managing access to customer information maintained the by the financial institution 104 is shown according to an example embodiment. The method 200 is performed by the FI computing system 110 (e.g., by the access control circuit 122, by the processor 116, etc.).

The method 200 begins when a customer is authenticated at 202. The FI computing system 110 receives an authentication request from the customer 102 via a computing device associated with the customer (e.g., a smartphone via a mobile banking application, a computing device via a web-based banking portal, etc.). In an alternate arrangement, the request may be received via an ATM associated with the financial institution 104. The authentication request indicates that an individual purporting to be the customer 102 is attempting to access the access control tower to manage access to the customer information associated with the customer 102. The authentication request includes customer authentication information (e.g., username, password, biometric, debit card dip in an ATM, PIN, etc.). Based on the customer authentication information, the request is either granted or denied. If the request is denied, step 202 of the method 200 does not occur, and the method 200 ends. The description of the method 200 continues for situations in which the customer 102 is authenticated.

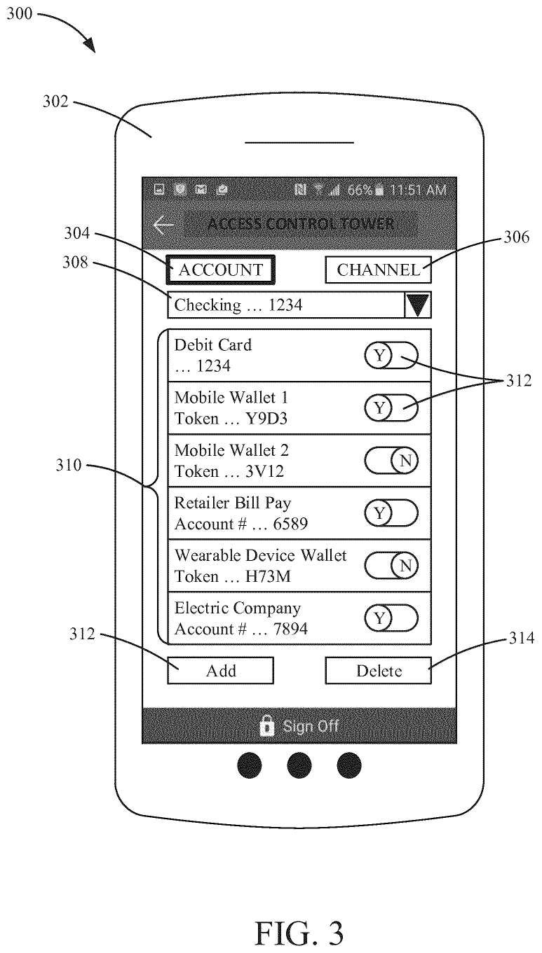

Access to the data control tower portal is provided at 204. After the customer 102 is authenticated, the FI computing system 110 provides the customer 102 access to the data control tower portal. The access to the data control tower portal may be facilitated through a computing device associated with the customer (e.g., a smartphone via a mobile banking application, a computing device via a web-based banking portal, etc.). The computing device presents interactive graphical user interfaces to the customer 102 through which the customer 102 can manage the access controls for the customer information. The data control tower portal may be part of a mobile banking application or a remote banking website associated with the financial institution 104. As noted above, the access to the customer information can be managed on an account level (e.g., managing all third-party and device access to a specific account) and on a channel level (e.g., managing all the information that a given customer device 108 or third-party system 106 can access). FIGS. 3 through 5 show example user interfaces associated with the data control tower that demonstrate various management features of the data control tower.

Referring to FIG. 3, a data control tower user interface 300 is shown according to an example embodiment. The user interface 300 is shown as a displayed on a mobile device 302. The user interface 300 includes an account toggle 304 and a channel toggle 306. As shown by the bolded outline of the account toggle 304, the account toggle 304 is selected. Accordingly, the user interface 300 is an account level management user interface. While in the account level management user interface, the customer 102 can select an account held with the financial institution 104 via the drop down box 308. As shown in FIG. 3, the customer 102 has selected a checking account. After selecting a specific account, a listing 310 of connected account access channels is populated. The listing 310 identifies each channel that the customer 102 has previously configured to access the checking account. Each entry in the listing 310 identifies a specific channel (e.g., a debit card, mobile wallet 1, mobile wallet 2, etc.), a channel access mechanism (e.g., a debit card number, a token identifier, an account number, etc.), and whether the channel access is currently active or inactive via a slider toggle 312 (where “Y” means the channel is active, and “N” means the channel is inactive). A channel may be a customer device 108 (e.g., a wearable device, a payment card, etc.) or a third-party system 106 (e.g., a mobile wallet, a retailer bill pay system, a utility company system, etc.).

The customer 102 can interact with a given slider toggle 312 to activate or deactivate a given channel's access to the selected account. For example, as shown in the user interface 300, the debit card is active (as shown by the associated slider toggle 312 being in the “Y” position). Accordingly, when the customer 102 attempts to use the debit card to make a payment (e.g., a purchase with a merchant) or withdraw cash from an ATM, the debit card is linked to the checking account identified in the drop down box 308, and the payment can go through or funds can be withdrawn (assuming the checking account has the appropriate balance). If the customer 102 interacts with the slider toggle 312 to deactivate the debit card's access to the checking account (e.g., by sliding the toggle 312 to the “N” position), the debit card is no longer linked to the checking account. If the sliding toggle 312 is in the “N” position and the customer 102 attempts to use the debit card at a merchant point-of-sale system or an ATM, the transaction will be denied or not processed from the checking account.

The user interface 300 also includes an add button 312 and a delete button 314. If the customer 102 interacts with the add button 312, the customer can add a new channel to the listing 310 of approved channels that are linked to the identified account. In doing so, the customer may need to register the customer device 108 (e.g., by providing a device identifier, by providing a primary account number of a payment card, by logging into an application or website via the customer device 108, etc.) or the third-party system 106 (e.g., by logging into a third-party website or application associated with the third-party system 106) with the financial institution 104 to pair the channel with the FI computing system 110. If the customer 102 interacts with the delete button 314, the customer 102 can select a channel in the listing 310 to revoke access of the selected channel to the account.

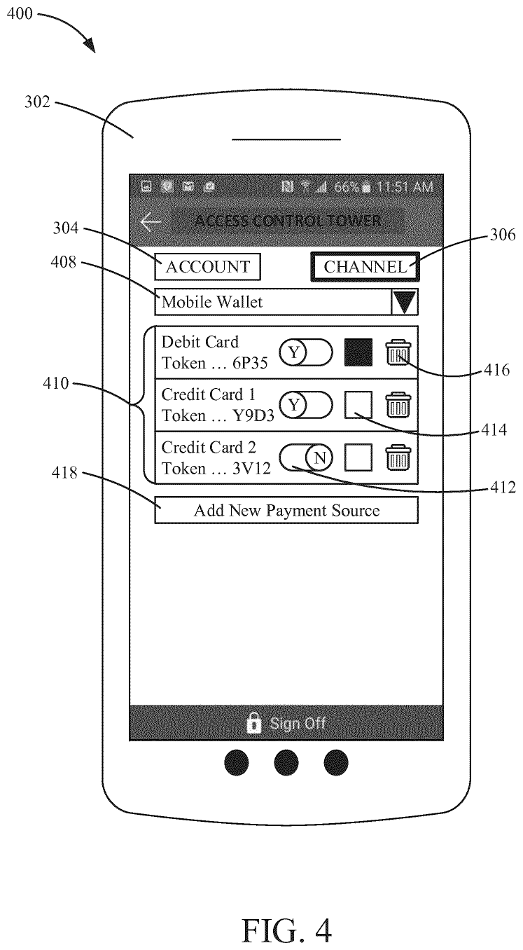

Referring to FIG. 4, a data control tower user interface 400 is shown according to an example embodiment. The user interface 400 is similar to the user interface 300. As such, like numbering is used between FIGS. 3 and 4 to designate like components of the user interfaces 300 and 400. The user interface 400 is shown as a displayed on the mobile device 302. As with the user interface 300, the user interface 400 includes the account toggle 304 and the channel toggle 306. As shown by the bolded outline of the channel toggle 306, the channel toggle 306 is selected. Accordingly, the user interface 400 is a channel level management user interface. While in the channel level management user interface, the customer 102 can select a channel that is paired with the financial institution 104 via the drop down box 408. A channel may be a customer device 108 (e.g., a wearable device, a payment card, etc.) or a third-party system 106 (e.g., a mobile wallet, a retailer bill pay system, a utility company system, etc.). As shown in FIG. 4, the customer 102 has selected a mobile wallet as the channel to manage. After selecting a specific channel, a listing 410 of accounts associated with the channel is populated. The listing 410 identifies each account that that the customer 102 has previously configured to be accessed by the selected channel. Each entry in the listing 410 identifies a specific account (e.g., a debit card, a credit card, etc.), an account access mechanism (e.g., a payment token), and whether the account is currently active or inactive via a slider toggle 412 (where “Y” means the account is active, and “N” means the account is inactive).

The customer 102 can interact with a given slider toggle 412 to activate or deactivate the selected channel's access to an account associated with the slider toggle 412. For example, as shown in the user interface 400, the token associated with credit card 1 is active (as shown by the associated slider toggle 412 being in the “Y” position). Accordingly, when the customer 102 attempts to make a payment with the mobile wallet (e.g., a purchase with a merchant) credit card 1 is listed as an option for the payment source of the transaction. If the customer 102 interacts with the slider toggle 412 to deactivate the channel's access to the token associated with credit card 1 (e.g., by sliding the toggle 412 to the “N” position), the credit card 1 is no longer listed as a payment source in the mobile wallet (or is listed as an unavailable payment source).

Each entry in the listing 410 also includes a default payment indicator 414 and a delete payment button 416. The default payment indicator 414 is highlighted to indicate the default payment source of the mobile wallet. As shown in FIG. 4, the selected default payment method for the mobile wallet is the debit card. If the customer 102 interacts with the default payment indicator 414 of a different entry (e.g., credit card 1 or credit card 2), the customer 102 can change the default payment source for the mobile wallet even though the customer is not interacting directly with the mobile wallet. If the customer 102 interacts with the delete payment button 416 for a given entry, the customer 102 can remove the associated payment source from the mobile wallet.

Still referring to FIG. 4, the user interface 400 also includes an add new payment source button 418. If the customer 102 interacts with the add new payment source button 418, the customer 102 can provision a payment token associated with a new payment source to the mobile wallet. The customer 102 can manually input the payment card information (e.g., primary account number, expiration date, billing address, card security code, card verification value, etc.) or select a payment card that the customer 102 has that is associated with (i.e., issued by) the financial institution 104. When the payment card information is provided by the customer 102, the FI computing system 110 can automatically request a payment card token (e.g., from a payment network associated with the payment card) and transmit the payment card token to the mobile wallet system (e.g., a third-party system 106 associated with the mobile wallet) such that the payment card is provisioned to the mobile wallet.

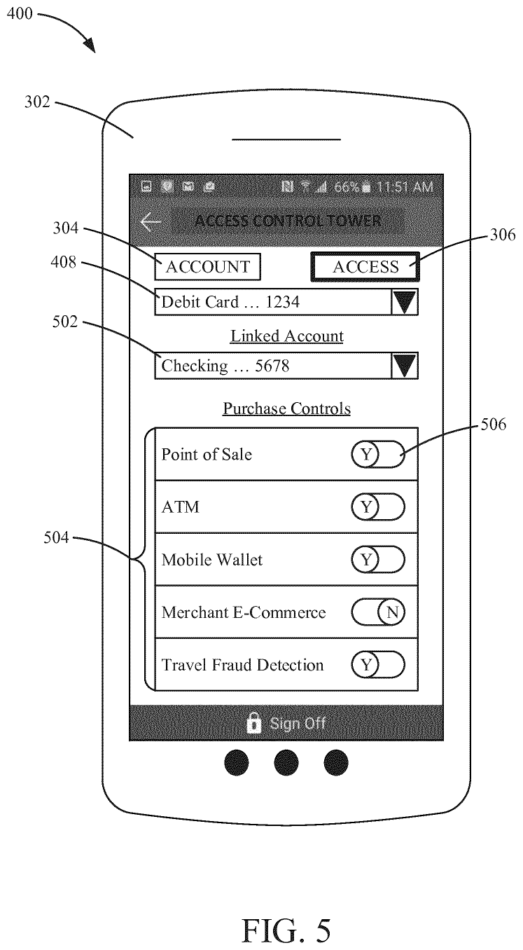

Referring to FIG. 5, a data control tower user interface 500 is shown according to an example embodiment. The user interface 500 is similar to the user interfaces 300 and 400. As such, like numbering is used between FIGS. 3 through 5 to designate like components of the user interfaces 300, 400, and 500. The user interface 500 is shown as a displayed on the mobile device 302. As with the user interfaces 300 and 400, the user interface 500 includes the account toggle 304 and the channel toggle 306. As shown by the bolded outline of the channel toggle 306, the channel toggle 306 is selected. Accordingly, the user interface 500 is a channel level management user interface. While in the channel level management user interface, the customer 102 can select a channel that is paired with the financial institution 104 via the drop down box 408. As shown in FIG. 5, the customer 102 has selected a debit card as the channel to manage. The debit card channel of FIG. 5 has different manageable features than the mobile wallet of FIG. 4. Accordingly, the specific channel level management user interfaces presented to the customer 102 while accessing the access control tower portal may differ depending on the channel selected by the user.

The debit card specific user interface 500 includes a linked account drop down box 502. The linked account drop down box 502 allows the customer 102 to change the account associated with the selected debit card. As shown in FIG. 5, the debit card is currently linked to a checking account ending in “5678”. If the customer 102 has additional demand deposit accounts with the financial institution 104, the customer 102 selects a different account to associate the debit card with via the drop down box 502.

Additionally, the user interface 500 includes a plurality of different purchase controls 504. Each of the purchase controls 504 includes a toggle slider 506 that allows the customer 102 to activate or deactivate a particular control associated with the debit card (where “Y” means the feature is active, and “N” means the feature is inactive). The purchase controls 504 may include a point of sale control that either permits or blocks the debit card from being used at a merchant point of sale system, an ATM control that either permits or blocks the debit card from being used at an ATM, a mobile wallet control that either permits or blocks the debit card from being used in a mobile wallet, a merchant e-commerce control that either permits or blocks the debit card from being stored at a merchant e-commerce site as a stored payment method, a travel fraud detection control that turns on or off a fraud detection feature, and the like. The customer 102 can interact with a given toggle slider 506 to activate or deactivate the associated purchase control 504. The available purchase controls may vary by channel.

Referring again to FIG. 2 and the method 200, updated access permissions or settings are received at 206. The FIG. computing system 110 receives the updated access permissions or settings from the customer 102 via the access control tower portal (e.g., from a computing device that the customer 102 is using to access the access control tower portal). The updated access permissions or settings may relate to any change to access permissions or settings for a specific account held by the customer 102 with the financial institution 104 or for a specific information access channel being registered with or that has already been registered with the financial institution 104. For example, the updated access permissions or settings may relate to any of the updated access permissions or settings that are described above with respect to FIGS. 3 through 5.

The FI computing system 110 determines if external action is required to implement the updated access permissions or settings at 208. In some arrangements, the type of access permission or setting being updated requires that the FI computing system 110 transmits commands to a customer device 108 or to a third-party system 106 to implement the updated access permissions or settings. For example, if the updated access permission or setting relates to revoking or provisioning a payment token stored on a customer device 108, the FI computing system 110 may need to send a command to either (1) deactivate or remove the payment token from the customer device 108 or the third-party systems 106 affiliated with the mobile wallet (e.g., a third-party mobile wallet server, a payment network server that manages a token vault associated with the payment token, etc.) or (2) activate or provision the token to the mobile wallet via the customer device 108 and/or the third-party systems 106. In other arrangements, the type of access permission or setting being updated can be performed at the FI computing system 110 without additional commands sent to a customer device 108 or a third-party system 106. For example, if the updated access permission or setting relates to revoking a third-party's access to account balance information, the FI computing system 110 can perform an internal update at the FI computing system 110 adjusting the API permissions associated with the third-party without the need to send a command to the third-party system 106 associated with the affected third-party.

If external action is required, commands are transmitted to the appropriate recipient at 210. The FI computing system 110 transmits the update commands to the appropriate third-party systems 106 and/or customer devices 108. If no external action is required, the updated access permissions or settings are implemented at 212. The FI computing system 110 updates internal account access permissions or settings in the accounts database 124. Additionally, in some arrangements, the update to the account access permissions or settings requires both external and internal action. In such arrangements, both steps 210 and 212 are performed. Based on the updated settings and permissions, the FI computing system 110 facilitates the sharing (or denial of requests to access) customer information to the external systems (e.g., customer devices 108 and third-party systems 106).

The above-described authentication systems and methods provide for more secure transactions and more secure computer access systems. The systems and methods utilize location information related to a user device associated with a user involved with a transaction or login attempt. The location information may be packaged as a digital fingerprint, which can only be recreated by the specific user device associated with the user. Accordingly, the digital fingerprint is difficult—if not impossible—to spoof by a fraudster or by another device associated with the fraudster.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more dedicated processors communicatively coupled to one or more dedicated memory or memory devices. In this regard, the one or more dedicated processors may execute instructions stored in the dedicated memory or may execute instructions otherwise accessible to the one or more dedicated processors. In some embodiments, the one or more dedicated processors may be embodied in various ways. The one or more dedicated processors may be constructed in a manner sufficient to perform at least the operations described herein. In some embodiments, the one or more dedicated processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more dedicated processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more dedicated processors may take the form of a single core processor, multi-core processor (e.g., a dual core processor, triple core processor, quad core processor, etc.), microprocessor, etc.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A method of changing accessibility of accounts administered by a financial institution computing system comprising one or more processors, the method comprising:
receiving, by the financial institution computing system, a first selection to disable a first third-party account from accessing a financial account of a user;
configuring, by the financial institution computing system, in response to the first selection, a first application programming interface (API) to disallow access to the financial account by the first third-party account, wherein configuring the first API comprises updating, by the financial institution computing system, in response to the first selection, a permission for the first API via which a first external device or system accesses the financial account for the first third-party account;
receiving, by the financial institution computing system, from the first external device or system via the first API, a first request to access the financial account;
transmitting, by the financial institution computing system, to the first external device or system via the first API, based on the updated permission, a denial of the first request received via the first API from the first external device or system;
receiving, by the financial institution computing system, a second selection to enable a second third-party account to access the financial account;
provisioning, by the financial institution computing system responsive to the second selection, an account access token that corresponds to the financial account, the second third-party account, and a second external device or system corresponding to the second third-party account;
receiving, by the financial institution computing system, from the second external device or system via the first API or a second API, a second request to access the financial account using the account access token; and
transmitting, by the financial institution computing system, to the second external device or system via the first API or the second API, based on the account access token, the account data corresponding to the financial account in response to the second request.

2. The method of claim 1, further comprising transmitting, by the financial institution computing system, to a computing device of the user, an identification that the financial account of the user is accessible to the first third-party account and inaccessible to the second third-party account for display by the computing device.

3. The method of claim 1, further comprising displaying, via a graphical user interface of a computing device of the user, a listing comprising (i) the first third-party account that is administered by the first external device or system, (ii) a first indication that the financial account is accessible to the first third-party account, (iii) the second third-party account that is administered by the second external device or system, and (iv) a second indication that the financial account is inaccessible to the second third-party account.

4. The method of claim 1, further comprising displaying, via a graphical user interface of a computing device of the user, a first toggle state corresponding to the first third-party account, and a second toggle state corresponding to the second third-party account, wherein a first toggle in the first toggle state visually indicates that the financial account of the user is accessible to the first third-party account, and a second toggle in the second toggle state visually indicates that the financial account is inaccessible to the second third-party account.

5. The method of claim 3, wherein the first selection is detected via the first toggle and the second selection is detected via the second toggle.

6. The method of claim 3, further comprising updating the first toggle to visually indicate that the financial account is not accessible to the first third-party account in response to the first selection, and updating the second toggle to visually indicate that the financial account is accessible to the second third-party account in response to the second selection.

7. The method of claim 1, further comprising:
receiving, by the financial computing system from the second external device or system via the first API or the second API, prior to the first selection, a third request to access the financial account; and
transmitting, by the financial institution computing system, to the second external device or system via the first API or the second API, account data corresponding to the financial account in response to the third request.

8. The method of claim 1, further comprising:
receiving, by the financial institution computing system, a third selection to enable access by the first third-party account to the financial account; and
transmitting, by the financial institution computing system, and in response to the third selection, a command to the first external device or system to add a second account access token associated with the financial account to a mobile wallet in order to add the financial account to the mobile wallet.

9. The method of claim 8, wherein the financial institution computing system is associated with a financial institution, and wherein the mobile wallet is not operated by the financial institution.

10. The method of claim 8, further comprising:
receiving, by the financial institution computing system, a fourth selection to disable access by the first third-party account to the financial account; and
transmitting, by the financial institution computing system, and in response to the fourth selection, a second command to the first external device or system to remove the second account access token associated with the financial account from the mobile wallet in order to remove the financial account from the mobile wallet.

11. The method of claim 1, further comprising applying, based on the first and second selections, purchase controls to a payment card associated with the financial account, wherein the purchase controls prevent the payment card from being used at one or both of an automated teller machine or a merchant point of sale.

12. The method of claim 1, further comprising:
receiving, by the financial institution computing system, a third selection to enable access by the first third-party account to the financial account; and
configuring, by the financial institution computing system, the first API to communicate with the first external device or system and permit the first external device or system to access the financial account.

13. A financial institution computing system comprising one or more processors configured to:
receive a first selection to disable a first third-party account from accessing a financial account of a user;
configure, in response to the first selection, a first application programming interface (API) to disallow access to the financial account by the first third-party account, wherein configuring the first API comprises updating, by the financial institution computing system, in response to the first selection, a permission for the first API via which a first external device or system accesses the financial account for the first third-party account;
receive, from the first external device or system via the first API, a first request to access the financial account;
transmit, to the first external device or system via the first API, based on the updated permission, a denial of the first request received via the first API from the first external device or system;
receive a second selection to enable a second third-party account to access the financial account;
provision, responsive to the second selection, an account access token that corresponds to the financial account, the second third-party account, and a second external device or system corresponding to the second third-party account;
receive, from the second external device or system via the first API or a second API, a second request to access the financial account using the account access token; and
transmit, to the second external device or system via the first API or the second API, based on the account access token, the account data corresponding to the financial account in response to the second request.

14. The financial institution computing system of claim 13, the one or more processors further configured to transmit, to a computing device of the user, an identification that the financial account of the user is accessible to the first third-party account and inaccessible to the second third-party account for display by the computing device.

15. The financial institution computing system of claim 13, the one or more processors further configured to:
receive, from the second external device or system via the first API or the second API, prior to the first selection, a third request to access the financial account; and
transmit, to the second external device or system via the first API or the second API, account data corresponding to the financial account in response to the third request.

16. The financial institution computing system of claim 13, the one or more processors further configured to:
receive a third selection to enable access by the first third-party account to the financial account; and
transmit, in response to the third selection, a command to the first external device or system to add a second account access token associated with the financial account to a mobile wallet in order to add the financial account to the mobile wallet.

17. The financial institution computing system of claim 13, the one or more processors further configured to:
receive a fourth selection to disable access by the first third-party account to the financial account; and
transmit, in response to the fourth selection, a second command to the first external device or system to remove the second account access token associated with the financial account from the mobile wallet in order to remove the financial account from the mobile wallet.

18. The financial institution computing system of claim 13, the one or more processors further configured to apply, based on the first and second selections, purchase controls to a payment card associated with the financial account, wherein the purchase controls prevent the payment card from being used at one or both of an automated teller machine or a merchant point of sale.

19. The financial institution computing system of claim 13, the one or more processors further configured to:
receive a third selection to enable access by the first third-party account to the financial account; and
configure the first API to communicate with the first external device or system and permit the first external device or system to access the financial account.

20. A non-transitory computer-readable storage medium comprising instructions executable by one or more processors to:
receive a first selection to disable a first third-party account from accessing a financial account of a user;
configure, in response to the first selection, a first application programming interface (API) to disallow access to the financial account by the first third-party account, wherein configuring the first API comprises updating, in response to the first selection, a permission for the first API via which a first external device or system accesses the financial account for the first third-party account;
receive, from the first external device or system via the first API, a first request to access the financial account;
transmit, to the first external device or system via the first API, based on the updated permission, a denial of the first request received via the first API from the first external device or system;
receive a second selection to enable a second third-party account to access the financial account;
provision, responsive to the second selection, an account access token that corresponds to the financial account, the second third-party account, and a second external device or system corresponding to the second third-party account;
receive, from the second external device or system via the first API or a second API, a second request to access the financial account using the account access token; and
transmit, to the second external device or system via the first API or the second API, based on the account access token, the account data corresponding to the financial account in response to the second request.
